(19) United States
(12) Patent Application Publication
(10) Pub. No.: US 2007/0156612 A1
(43) Pub. Date: Jul. 5, 2007

(54) Method for addressing mail using an identification code and a database to determine the physical address of a mail item.

(76) Inventor: Jacques Philippe LaFleur, Annapolis, MD (US)

Correspondence Address: Jacques P. LaFleur, 122 Sunset Dr., Annapolis, MD, 21403-4116, US

(21) Appl. No.: 11/277,367

(22) Filed: Mar. 24, 2006

Related U.S. Application Data
(60) Provisional application No. 60/754,708, filed on Dec. 30, 2005.

(51) Int. Cl. G06F 17/00

(52) U.S. Cl. 705/401

(57) ABSTRACT

A method for addressing mail by initially using an identification code to address the mail item instead of a physical address. The identification code is then used to determine the physical destination address of the mail item. The foregoing is accomplished by using an identification code to initially address a mail item; using a scanner, scanning device, or scanning system to read or scan the identification code; linking or associating the identification code to a corresponding physical address by utilizing a computer system or database; and finally, using a printer, printing device, or printing system to readdress or re-label the mail item with the determined physical destination address information.

### FIELD OF THE INVENTION

The invention relates generally to mailing systems and more specifically to mail addressing systems, techniques, and methods.

### BACKGROUND OF THE INVENTION

Processing a change of address can be a costly and time-consuming task. Persons, businesses, government offices, and other entities can change their physical mailing address frequently because of moves, relocations, and transfers. Notifying all contacts, customers, and liaisons of the new physical address information can be a costly and time-consuming task. In addition, updating all documents, letterheads, websites, and other correspondence with the new physical address information can be a costly and time-consuming task as well. There is a need for a more efficient mail addressing system which alleviates the time and cost currently required to process a change of address. This invention addresses the aforementioned need.

### SUMMARY OF THE INVENTION

The invention alleviates the time and cost currently required to process a change of address by introducing a new method to address mail using an identification code to initially address the mail item instead of a physical address. The identification code is given to all contacts, customers, liaisons, and used on all documents, letterheads, websites, and other correspondence. The physical destination address of the mail item is later determined by utilizing a computer system or database to link or associate the identification code to its corresponding physical address information. Therefore, processing a change of address is performed by updating the aforementioned computer system or database with the identification code's new physical address information. The update to the computer system or database is performed in lieu of the costly and time-consuming task of notifying all contacts, customers, liaisons, and updating all documents, letterheads, websites, and other correspondence.

The foregoing is accomplished by using an identification code to initially address a mail item; using a scanner, scanning device, or scanning system to read or scan the identification code; linking or associating the identification code to a corresponding physical address by utilizing a computer system or database; and finally, using a printer, printing device, or printing system to readdress or re-label the mail item with the determined physical destination address information.

### DESCRIPTION OF THE PREFERRED EMBODIMENT

An identification code is used to initially address a mail item instead of a physical mailing address. The identification code can be comprised of numbers, letters, words, symbols or any combination thereof and can be of any length. The identification code is given to all contacts, customers, and liaisons. The identification code is also used on documents, letterheads, websites, and other correspondence to signify the mailing address of the person, business, government office or other entity. The identification code corresponds to a physical address. A computer system or database is used to store the identification code and its corresponding physical address information.

Persons, businesses, government offices, and other entities can apply for and/or update their identification code and its corresponding physical address information via a website, computer system, or database. Identification codes can be assigned to a variety of entities including but not limited to persons, businesses, government offices, and to an individual worker or entity within an office building or organization. For example, an entity could have two identification codes: one for a home address and one for a work address. In another example, an identification code can be assigned to a specific office or bureau within a larger organization. Upon assignment of an identification code, an entity can give their identification code to all customers, liaisons, and contacts instead of their physical address information. The identification code can also be used on the entity's documents, letterheads, websites, and other correspondence. Senders can then address mail intended for the entity or recipient by using the entity's or recipient's identification code instead of a physical address.

If the physical address of a person, business, government office, or other entity changes, an update to the database is performed so that the identification code of the person, business, government office, or other entity now corresponds to a new physical address. As each mail item with the identification code is processed, the new physical address information stored within the computer system or database is automatically used to readdress or re-label, process, and deliver the mail item. A change of address is therefore processed by performing an update of the identification code's corresponding physical address information in the aforementioned computer system or database in lieu of updating all documents, letterheads, websites, other correspondence, and notifying all contacts, customers, and liaisons with the new physical address information. Note that the identification code remains static and does not change throughout this process. In summary, a change of address can be performed by simply updating the identification code's corresponding physical address information in the computer system or database.

In addition to the foregoing benefits of using an identification code to initially address mail, certain privacy concerns are addressed as well. In order to receive mail, a recipient only needs to give a sender their identification code and not their physical address information. The mail item can be successfully delivered to the recipient without the sender being aware of the recipient's physical address information.

As mail items addressed with the aforementioned identification codes are processed by the mail processing or handling entity, the identification codes are scanned or read by a scanner, scanning device, or scanning system. Once the identification codes are read or scanned, the identification codes are communicated to a computer system or database that contains the identification codes and their corresponding physical address information. Each identification code corresponds to a physical address. The computer system or database is utilized to link or associate the identification codes to their corresponding physical address information. Upon the determination of the identification code's physical address information, the physical address information is communicated to a printer, printing device, or printing system.

The printer, printing device, or printing system receives the determined physical address information of the mail item's identification code. The determined physical address information is then used to readdress or re-label the mail item. The printer, printing device, or printing system prints the physical address information directly onto the mail item. As an alternative, the printer, printing device, or printing system prints the physical address information onto a sticker which is then fastened or affixed to the mail item. As another alternative, the printer, printing device, or printing system prints the physical address information onto an envelope or wrapper which then encompasses or wraps the mail item.

After the mail item has been readdressed or re-labeled with the determined physical address information of the mail item's identification code, the mail item can be handled, processed, and delivered in the same manner that all other normally addressed mail is processed. FIG. 1 is an overview in flowchart form of the method, process flow, and major steps included in the aforementioned mail addressing system.

The above specification introduces an improved method for addressing mail and subsequently readdressing or re-labeling mail which alleviates the time and cost currently required to process a change of address. It is realized that the above description may indicate to those skilled in the art additional ways in which the principles of this invention may be used without departing from the spirit. Therefore, it is intended that this invention be limited only by the scope of the appended claims.

### BRIEF DESCRIPTION OF DRAWINGS

FIG. 1 is a flowchart of the method or process flow of the invention.

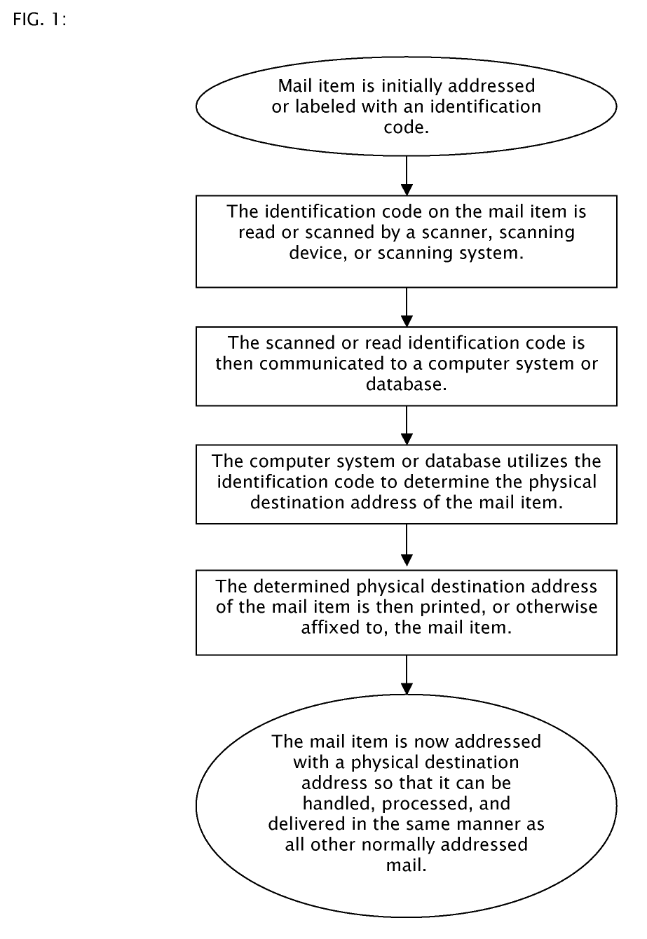

The embodiments of the invention in which an exclusive property or privilege is claimed are defined as follows:

1. A method for addressing mail using an identification code to determine the physical destination address of a mail item which comprises of:
a. Initially addressing, labeling, or associating a mail item with an identification code;
b. Scanning or reading the identification code of the mail item;
c. Communicating the mail item's scanned or read identification code to a computer system or database;
d. Utilizing the computer system or database to determine the physical destination address of the mail item by linking or associating the mail item's scanned or read identification code to its corresponding physical address;
e. Printing the determined physical destination address onto the mail item after the identification code's corresponding physical address has been determined.

2. The method claimed in claim 1, wherein the determined physical destination address of the mail item is printed onto a sticker that is then fastened or affixed to the mail item after the identification code's corresponding physical address has been determined.

3. The method claimed in claim 1, wherein the determined physical destination address of the mail item is printed onto an envelope or wrapper which then encompasses or wraps the mail item after the identification code's corresponding physical address has been determined.

4. The method claimed in claim 1, further including the step of utilizing a website, computer system, or database to facilitate the application for identification codes, the assignment of identification codes, and the updating of identification codes and their corresponding physical address information.
